(19) United States
(12) Patent Application Publication
(10) Pub. No.: US 2008/0038592 A1
(43) Pub. Date: Feb. 14, 2008

(54) METHOD OF OPERATING A SOLID OXIDE FUEL CELL HAVING A POROUS ELECTROLYTE

(76) Inventors: Harlan Anderson, Rolla, MO (US); Toshio Suzuki, Rolla, MO (US); Piotr Jasinski, Gdansk (PL); Vladimir Petrovsky, Rolla, MO (US)

Correspondence Address: SOMMER BARNARD ATTORNEYS,P.C., ONE INDIANA SQ, SUITE 3500, INDIANAPOLIS, IN, 46204, US

(21) Appl. No.: 11/837,906

(22) Filed: Aug. 13, 2007

Related U.S. Application Data
(62) Division of application No. 10/961,680, filed on Oct. 8, 2004.

(51) Int. Cl. H01M 8/04; B01D 59/40

(52) U.S. Cl. 429/12; 205/687

(57) ABSTRACT

A method of extracting electrochemical energy from flowing hydrocarbon fluids, including positioning a porous electrolyte layer between a substantially porous anode layer and a substantially porous cathode layer to define a fuel cell, flowing a mixture of hydrocarbon fuel and oxidant over the fuel cell, heating the fuel cell to at least a predetermined minimum temperature, and extracting electrochemical energy from fuel cell. The electrolyte is typically an ionic or protonic conductor.

### CROSS-REFERENCE TO RELATED APPLICATIONS

This application is a divisional of co-pending U.S. patent application Ser. No. 10/961,680, filed Oct. 8, 2004.

### TECHNICAL FIELD

The present novel technology relates generally to the field of electrochemical power generation, and, more specifically, to the solid oxide fuel cell systems.

### BACKGROUND

A fuel cell is a power generating electrochemical device that reacts chemical fuel with an oxidant to produce an electrical potential. A conventional fuel cell consists of two electrodes positioned around an electrolyte that serves to physically separate the chemical reactants (i.e., the fuel and the oxidant) from one another. The fuel may be hydrogen or a hydrocarbon (such as methane or propane) and the oxidant is typically oxygen. In the conventional fuel cell, oxygen flows over one electrode and hydrogen over the other. The reaction of hydrogen and oxygen generates electricity, water and heat. In the conventional fuel cell, hydrogen fuel is fed to the anode and oxygen is fed to the cathode. At the anode, atomic hydrogen is ionized to produce protons and electrons. The protons are conducted through the electrolyte, which is typically an ionic conductor and an electrical insulator (i.e., the electrolyte is characterized by a very high resistance to the flow of electrons). The electrons therefore must travel around the electrolyte to the cathode and can thus be directed through a load to produce useful work. At the cathode, protons that have migrated through the electrolyte are combined with oxygen and electrons to balance the charges and produce water.

Since fuel cells operate on the principles of electrochemistry rather than thermal combustion to produce power, fuel cells enjoy higher operating temperatures and greater energy conversion efficiencies. Further, fuel cell systems produce substantially less and much cleaner emissions than do known fuel combustion engines. However, although cleaner and more efficient than combustion, fuel cell technology is much newer and less commonplace than combustion technology, and is accordingly more expensive to support. While fuel cells are attractive for a myriad of reasons, including low pollution, high efficiency, low noise and increased power density, the first hurdle to be overcome in the expansion of fuel cell technology is the development of more cost competitive (i.e., cheaper) fuel cell hardware and support systems that can compete with conventional combustion-based power-generating engines on the basis of cost, weight and volume.

Another kind of fuel cell design, suggested decades ago by Van Gool but only recently given any real attention, is the single chamber fuel cell design. The single chamber solid oxide fuel cell (SC-SOFC) utilizes surface migration of fuel and oxygen over the electrolyte to accommodate a mixture of reactants (i.e., a single mixture of fuel and oxidant). While such a mixture of reactants experiences a thermodynamic driving force urging reaction, reactants may be chosen with sufficiently high activation barriers, slow reaction kinetics at room temperature, or the like, that the reaction effectively does not begin until the reactants are fed to the fuel cell electrodes. Another advantage of the SC-SOFC design is that use of mixed reactants obviates the requirement of bulky and heavy manifolding and gastight sealing for the separate supply of fuel and oxidants. Thus, the system may be simplified and lightened at the same time.

Densified porous, gas permeable materials have been used for the electrolytes, as they effectively increase the surface area, and thus the available migration paths, over which migration takes place. This allows for increased migration of the fuel and oxidant species. However, SC-SOFC designs are still limited by the diffusion rate of the reactant gasses in the mixture.

Further, by selectively choosing the electrode materials, a reduction reaction can be promoted at the cathode and an oxidation reaction at the anode, whilst the degree of parasitic reaction in the reactant mixture is negligible. The known SC-SOFC designs generally suffer the same disadvantages of the conventional fuel cells, and further are characterized by lower fuel efficiency and open cell voltages (usually due to parasitic fuel-oxidant reactions). With conventional electrode materials, the efficiency of mixed reactant fuel cells tend to be inferior to that of a conventional system in which the fuel and oxidant are maintained in separate feeds. However, other performance measures such as cost and power density may be significantly enhanced. A concern with mixed reactant fuel cells is that certain reactant mixtures have an inherent risk of uncontrolled catastrophic reaction (i.e., explosion). However, this risk may be minimized with proper handling of the mixture, since the reactants do not necessarily combine simply because the reaction product is thermodynamically more stable.

Another limitation of known fuel cells is that electrochemical reaction only occurs at an interface between three phases. In other words, electrochemical reaction is limited to sites on the catalyst where reactant and electrolyte meet together. This latter problem is not only a limitation in mixed reactant fuel cells, but is also a disadvantage of conventional fuel cells.

Thus, there exists a need for a SC-SOFC that enjoys increased fuel efficiency and higher voltage outputs than may be currently achieved. The present novel technology addresses this need.

### SUMMARY

One aspect of the present novel technology relates to a SC-SOFC design that incorporates a porous, non-densified yttria-stabilized zirconia (YSZ) electrolyte material and porous NiO-YSZ and (La_{0.8}Sr_{0.2})(Fe_{0.8}Co_{0.2})O₃ catalytic electrodes along with an optimizes linear flow rate of the fuel-oxidant gas mixture over the electrolyte to maximize the diffusion rate of the fuel and oxidant through the cell to increase the SC-SOFC's fuel efficiency and open cell voltage output.

One object of the present novel technology is to provide an improved fuel cell system. Related objects and advantages of the present novel technology will be apparent from the following description.

### BRIEF DESCRIPTION OF THE DRAWINGS

FIG. 1A is a perspective view of a first embodiment single chamber solid oxide fuel cell device of the present novel technology.

FIG. 1B is a perspective view of an alternate embodiment single chamber solid oxide fuel cell device of the present novel technology.

FIG. 2 is a 10,000× magnification SEM photomicrograph of a fracture surface of a porous YSZ electrolyte of the present novel technology.

FIG. 3A graphically displays I-V discharge profile and power density curves of the fuel cell of FIG. 1B at 556 degrees Celsius.

FIG. 3B graphically displays I-V discharge profile and power density curves of the fuel cell of FIG. 1B at 606 degrees Celsius for relatively low fuel gas flow rates.

FIG. 4 is a schematic illustration of the surface migration at the electrodes and electrolyte of the fuel cell of FIG. 1A.

FIG. 5A graphically displays of the impedance spectra of the fuel cell of FIG. 1B at 556 degrees Celsius.

FIG. 5B graphically displays of the impedance spectra of the fuel cell of FIG. 1B at 606 degrees Celsius for relatively low fuel gas flow rates.

FIG. 6 graphically displays the area of specific resistance (ASR) of the fuel cell of FIG. 1B at 556 and 606 degrees Celsius.

FIG. 7A graphically displays I-V discharge profile and power density curves of the fuel cell of FIG. 1B at 606 degrees Celsius for relatively high fuel gas flow rates.

FIG. 7B graphically displays of the impedance spectra of the fuel cell of FIG. 1B at 606 degrees Celsius for relatively high fuel gas flow rates.

### DESCRIPTION OF THE PREFERRED EMBODIMENTS

For the purposes of promoting an understanding of the principles of the novel technology and presenting its currently understood best mode of operation, reference will now be made to the embodiments illustrated in the drawings and specific language will be used to describe the same. It will nevertheless be understood that no limitation of the scope of the novel technology is thereby intended, with such alterations and further modifications in the illustrated device and such further applications of the principles of the novel technology as illustrated therein being contemplated as would normally occur to one skilled in the art to which the novel technology relates.

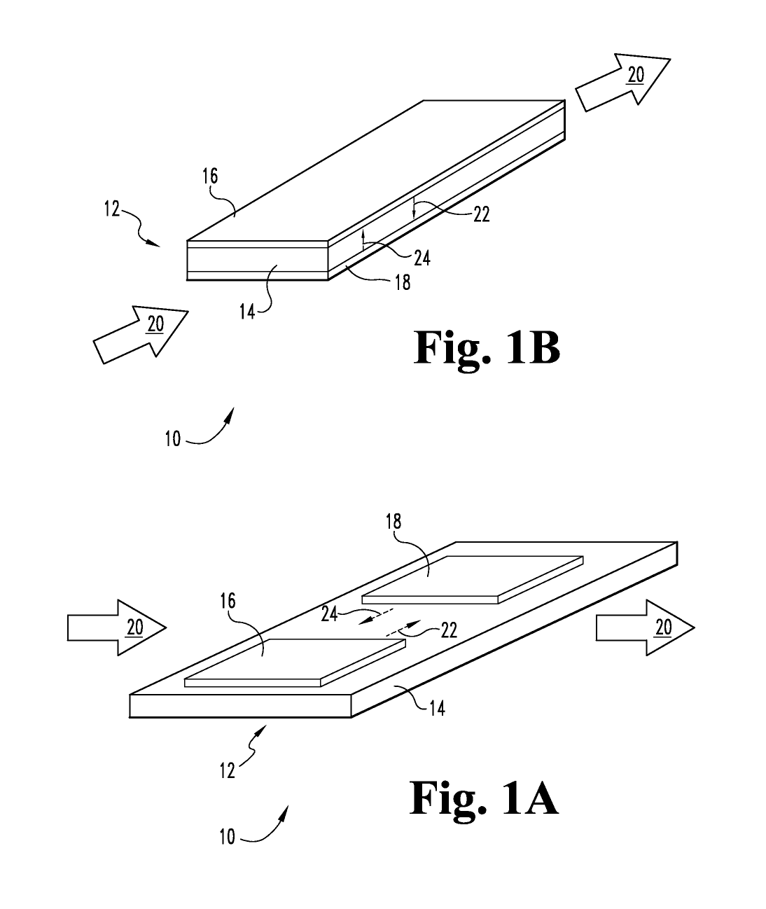

The present novel technology comprises multi-layer electrolyte/electrode compositions that are used as electrochemical power generation media (i.e., fuel cells). One embodiment of this novel technology is shown in FIG. 1A as fuel cell system 10. Fuel cell system 10 includes a fuel cell device 12, which comprises an electrolyte substrate layer 14, an anode layer 16 and a cathode layer 18. A fluidic fuel/oxidant mixture 20 is flowed over the fuel cell device 12 at a predetermined flow rate. Oxygen 24 diffuses through the cathode 18 and migrates along the electrolyte 14 towards the anode 16. Hydrocarbon fuel 21 is broken down into hydrogen 22 and carbonaceous molecules 23 at the anode 16, and the hydrogen 22 migrates from the anode 16 along the electrolyte 14 towards the cathode 18. The hydrogen 22 and carbonaceous molecules 23 are oxidized at the electrolyte 14 or near the anode 16. Since the anode 16 has a higher catalytic activity for the oxidation of fuel 21 than the cathode 18, an oxygen activity difference exists between the two electrodes 16, 18 and an electromotive force (EMF) is generated. Since the oxygen activity difference occurs locally in the region of the electrodes 16, 18, the oxygen potential may be sustained without the requirement of separation of the fuel 21 and oxidant 24 fluids. Thus, the requirement of gas- or fluid-tightness of the fuel cell system 10 is avoided. In an alternative embodiment (shown as FIG. 1B), the electrodes 16, 18 are positioned on opposite sides of the electrolyte layer 14.

The electrolyte layer 14 is preferably characterized as electrically conducting primarily via an ionic mechanism. In other words, the electrolyte 14 is primarily an ionic conductor. The electrolyte layer 14 is also preferably porous. Commonly used materials for the electrolyte layer 14 include zirconia (ZrO₂), doped zirconia, yttria (Y₂O₃) stabilized zirconia (YSZ), ceria (CeO₂), doped ceria, lanthanum-strontium galleate ((La, Sr) GaO₃) derivatives, and the like. YSZ is commercially available, and is typically found with yttria concentrations of about 8 atomic or molecular percent (the balance being zirconia). Preferable dopants for ceria include Gd, Sm, and the like. Dopants for zirconia include yttrium, yttria, and the like. Alternately, the electrolyte layer 14 may conduct via other mechanisms. For example, the electrolyte layer 14 could conduct electricity primarily via a protonic mechanism. Examples of protonically conducting electrolyte 14 materials include Ba(Y)CeO₃ and Sr(Y)CeO₃.

The anode layer 16 is preferably porous as well. Commonly used materials for the anode 16 layer include platinum (Pt), palladium (Pd), cobalt (Co), nickel (Ni) (either individually, in combination, as oxides, or as combinations of oxides), metal oxide-YSZ compounds (MO.YSZ), or the like. One preferred range of anode compositions includes at least about 30 volume percent nickel or nickel oxide with the balance being zirconia, ceria, YSZ or the like (translating roughly to at least about 80 weight percent Ni or NiO). This limitation arises from the connectivity requirement of nickel atoms arising from percolation of the nickel. If coated so as to yield better (electrical) connectivity, the minimum compositional requirement of the nickel/nickel oxide drops to about five percent.

The cathode layer 18 is also preferably porous. Commonly used cathode layer 18 materials include compounds formed of oxides of elements from the lanthanide series (the lanthanides) and the transition metals. One preferred cathode layer 18 composition is an oxide of the form ABO₃, wherein A is a lanthanide, such as La, and B is a transition metal such as Sr, Ca, Mg or Ba. Another preferred compositional range is La₁₋ₓSrₓQ_{y}Z_{1-y}O₃, wherein Q is Mn, Co, or Mg, and Z is Cu or Fe, 0≦x≦0.8, and 0≦y≦1.

In one embodiment, the electrolyte 14 is preferably formed onto an already fabricated anode layer 16, since the anode layer 16 is typically thicker and more structurally sound. Typical anode thickness is about 1 mm or less. The electrolyte layer 14 may be formed by any convenient process, such as by screen-printing precursor ink onto the anode substrate 16, and subsequently sintered to produce a porous electrolyte layer 14. Preferably, the cathode layer 18 is of comparable thickness and is likewise positioned on the electrolyte 14, such as by screen-printing. The cathode layer 18 is then preferably annealed. More preferably, the anode layer 16 and cathode layer 18 are porous. The anode 16 and cathode 18 may be separated by any convenient distances (for example 0.5, 1, 2 or more millimeters). In the case of the electrolyte layer 14 being positioned between the anode 16 and cathode 18 layers, the separation distance between the anode 16 and cathode 18 layers will be equal to the thickness of the electrolyte layer, which may be quite small if the electrode layer 14 is formed as a thin film.

Once produced, the fuel cell device 12 may be incorporated into a fuel cell system 10 including a heat source (such as a tube furnace or the like) to maintain the fuel cell 12 above a predetermined minimum temperature. A fuel/oxidant gas mixture 20 is flowed over the fuel cell device 12. The fuel portion 22 of the mixture 20 may be a hydrocarbon, such as methane, butane, propane, or the like, or may alternately be any appropriate combustible fluid. The oxidant portion 24 of the mixture 20 is typically air, oxygen, or an oxygen-rich gaseous composition, although other oxidizing fluids may be substituted. When the mixture 20 is flowing over the heated fuel cell device 12, power may be extracted from the fuel cell system 10 (such as through connected current collectors (for example, Pt, Pd, Au or Ag mesh) attached to the area of the electrode 16, 18).

Preferably, gas flow controllers (not shown) or the like are used to maintain the gas mixture 20 flow at a predetermined optimal rate, such as between about 300 and about 900 cubic centimeters per minute, to yield an optimum linear velocity over the fuel cell device 12. (As used herein, linear velocity is defined as ‘gas flow rate/gas flow cross sectional area’). The gas flow rate is a function of the geometry of the heat source (such as the diameter of a tube furnace, if a tube furnace is the heat source). Typically, the gas velocity is maintained between from about 40 to about 120 centimeters per second. The temperature of the fuel cell device 12 is preferably maintained above about 300 degrees Celsius, more preferably above about 550 degrees Celsius, and even more preferably above about 600 degrees Celsius (as measured without gas flowing over the cell 12, or as a set temperature, Tₛ; gas flowing over the fuel cell 12 has a cooling effect, which is generally more than offset by internal heat production when the cell 12 is operating).

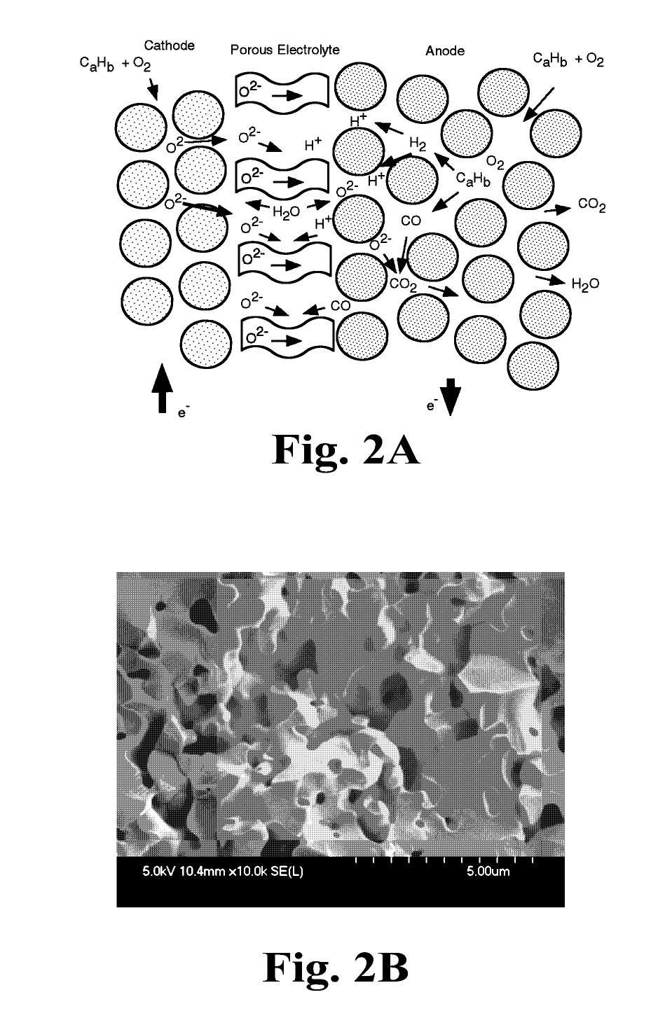

In one typical fuel cell system 10 produced and operated as described above, the cell 12 temperatures were measured using a thermocouple directly placed on the cell 12. Impedance spectroscopy techniques were utilized to investigate the cell 12 performance using a Solartron 1470 Battery Tester and 1255B Impedance Gain Phase Analyzer with a 4-probe configuration. The impedance spectra were obtained using a 1 mA load. The cell 12 measurements were conducted over 36 hours and showed reproducible results. The microstructure of the cell 12 was characterized by scanning electron microscopy (Hitachi S4700) and is illustrated in FIG. 2. FIG. 2 shows fracture surface SEM images of the porous electrolyte 14. The thickness of the electrolyte was about 18 μm. Well-connected open channels were observed in the electrolyte 14, which allow gas permeation and diffusion therethrough.

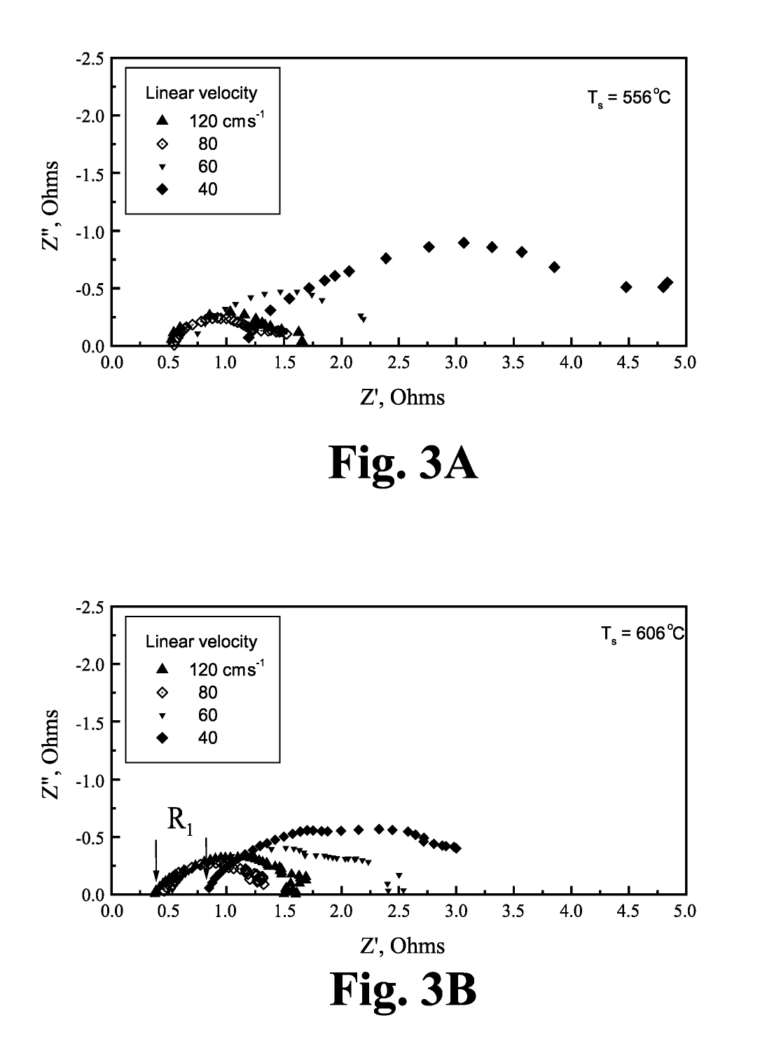

FIGS. 3A and 3B show the discharge profile of the cell 12 with different linear velocities of gas flow at 556 and 606 degrees Celsius (set temperatures), respectively. The porous electrolyte 14 provided a sufficient barrier to separate the oxygen activities at the electrodes 16, 18 by optimizing gas flow. Open circuit voltages (OCV) of the porous electrolyte fuel cell 12 were measured in the range of 0.68 to 0.78 volts and were dependant upon the linear velocity of the gas mixture 20. Comparably, the OCV for a densified 2 μm thick YSZ electrolyte cell was measured at about 0.8 V when run under identical same conditions.

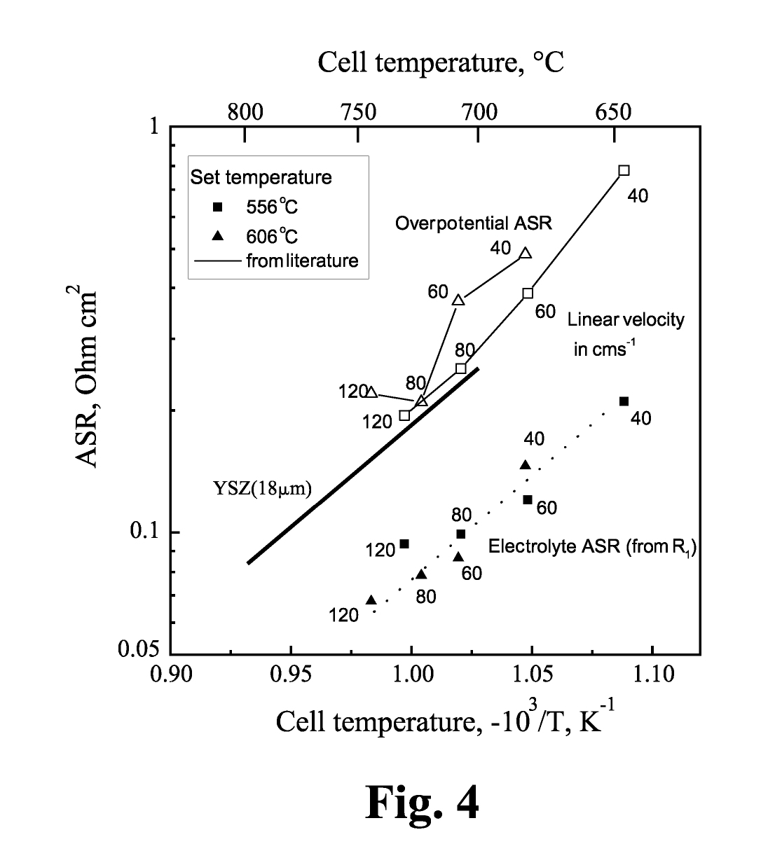

As shown in FIG. 4, H₂ or/and CO can diffuse from anode 16 to cathode 18 through the porous electrolyte 14 and as a result, oxygen 24 can be consumed at the cathode 18 and, accordingly, lower the oxygen partial pressure. Lowered oxygen partial pressure yields a decrease in the available OCV. This is borne out by an observed increase of the OCV as the linear velocity of the flowing gas mixture 20 is increased. The increase of linear velocity improves interfacial gas diffusion between the gas phase 20 and an electrode 16, 18 and results in increased catalytic activity at the electrode 16, 18, thereby increasing the OCV.

The cell 12 temperatures showed a strong dependence on the linear velocity of the flowing gas mixture 20. While the cell 12 temperature in air 24 (without fuel 22, and thus without the generation of electrochemical energy) decreased with increasing gas flow linear velocity (due to cooling from gas flow), the cell 12 temperature in air-fuel mixture 20 increased due to an increase of catalytic activity in the anode 16. Note that this is one of advantages of SC-SOFC and certainly contributes to the performance of the system 10 at relatively low operating temperature.

A maximum power density of about 0.66 watts per square centimeter was obtained from the system 10 at a temperature of 744 degrees Celsius (set temperature of 606 degrees Celsius) with a measured current density of 1.5 amps per square centimeter and a cell 12 voltage of 0.44 volts at 120 centimeters per second gas flow linear velocity. The performance of the cell 12 is dependent both upon the linear velocity of the gas mixture 20 over the cell 12 and the set temperature. Due to cooling from the gas flow, a degradation of cell performance with decreasing cell temperature occurs at excessively high gas flow linear velocities.

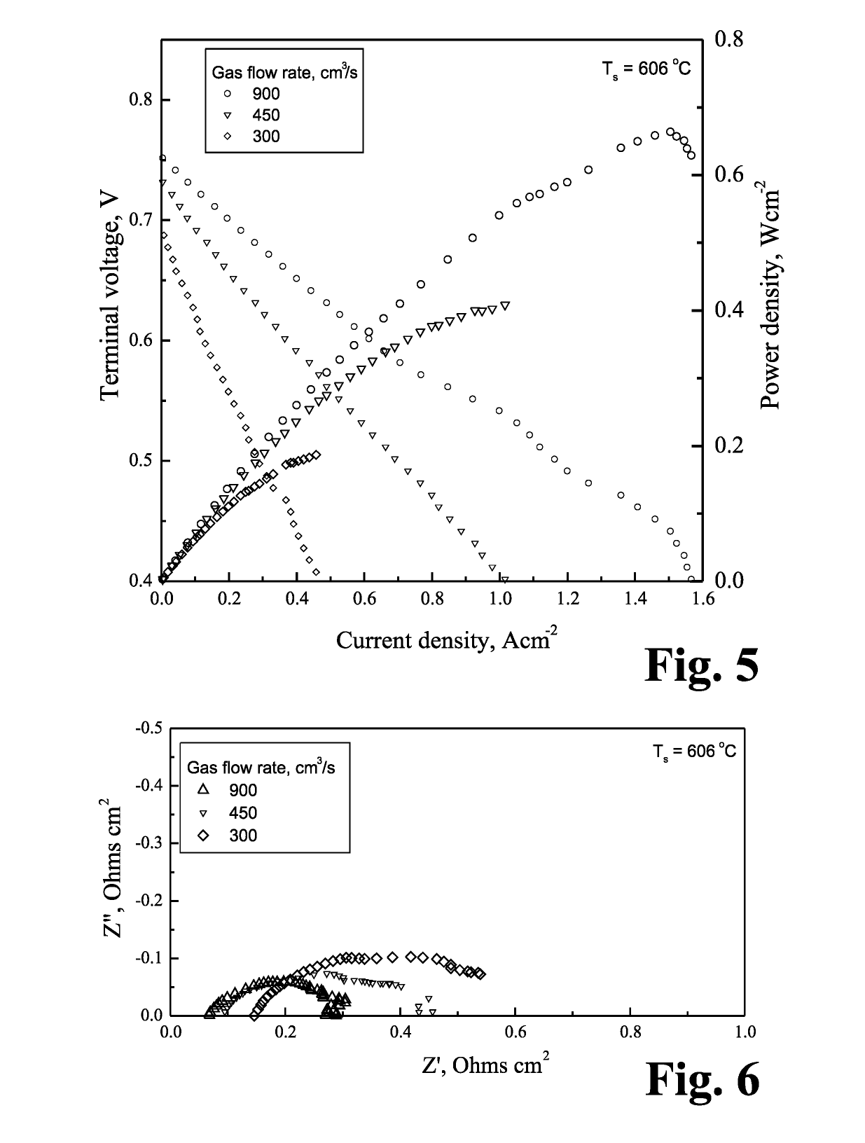

Impedance spectra for the porous electrolyte SC-SOFC system 10 are shown in FIGS. 5A and 5B. Relatively large electrode overpotentials exist (as compared to high frequency electrolyte resistances) due to gas diffusion and charge transfer effects. The overpotential resistances and the electrolyte resistances decrease as linear velocity of the flowing gas mixture 20 increases. As shown in FIGS. 5A and 5B, an increase of cell 12 temperature is considered the main reason for the high efficiency of the cell 12 performance. The effect of gas mixture 20 linear velocity was also observed, i.e., higher linear velocities yielded improved cell efficiency for a given cell temperature. An increase of linear velocity typically results in an improvement of gas diffusion in the vicinity of electrodes and, therefore, overpotential resistances are reduced and catalytic activity of the anode 16 is increased, resulting in an increased cell temperature.

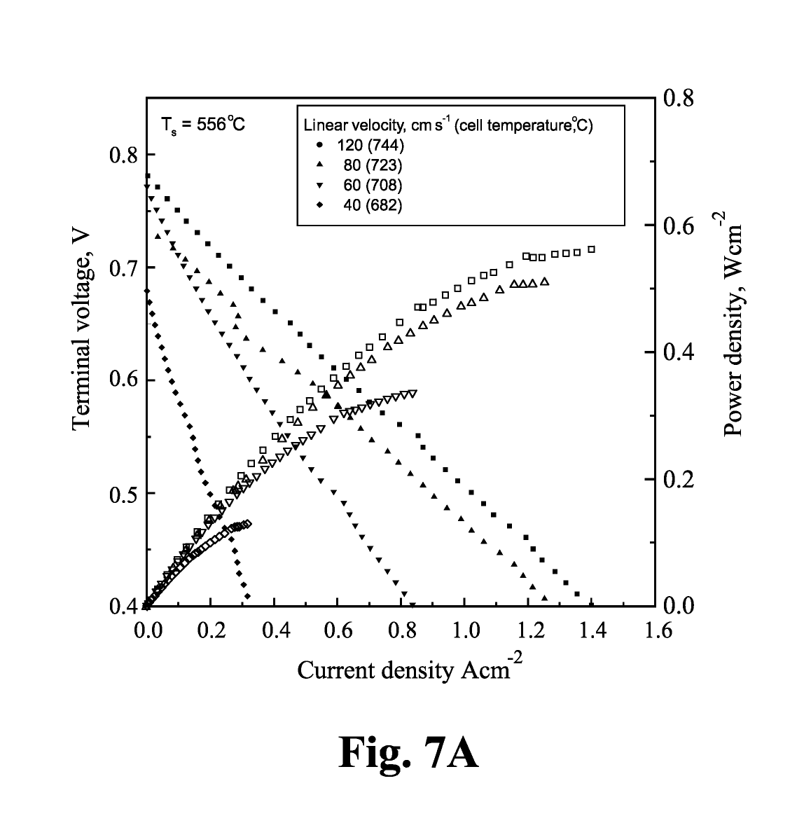

FIG. 6 shows the area specific resistances (ASR) for the electrolyte 14 and overpotential as a function of cell temperature. As can be seen, the overpotential ASR showed a dependence on linear velocity with lower ASR being obtained for higher linear velocity, which resulted in better performance of the cell 12. It is also seen that the ASRs of the porous electrolyte 14 were relatively low. It is inferred that the cell 12 is characterized by increased ionic conductivity in porous electrolyte 14 due to the surface migration effect.

The electrolyte 14 resistance had little effect on the performance of the cell, with the performance being limited by the electrode overpotential. Thus, a SC-SOFC may be produced having a porous electrolyte 14, which opens the opportunities to design both thermally and mechanically more robust cell designs operated on hydrocarbon fuels.

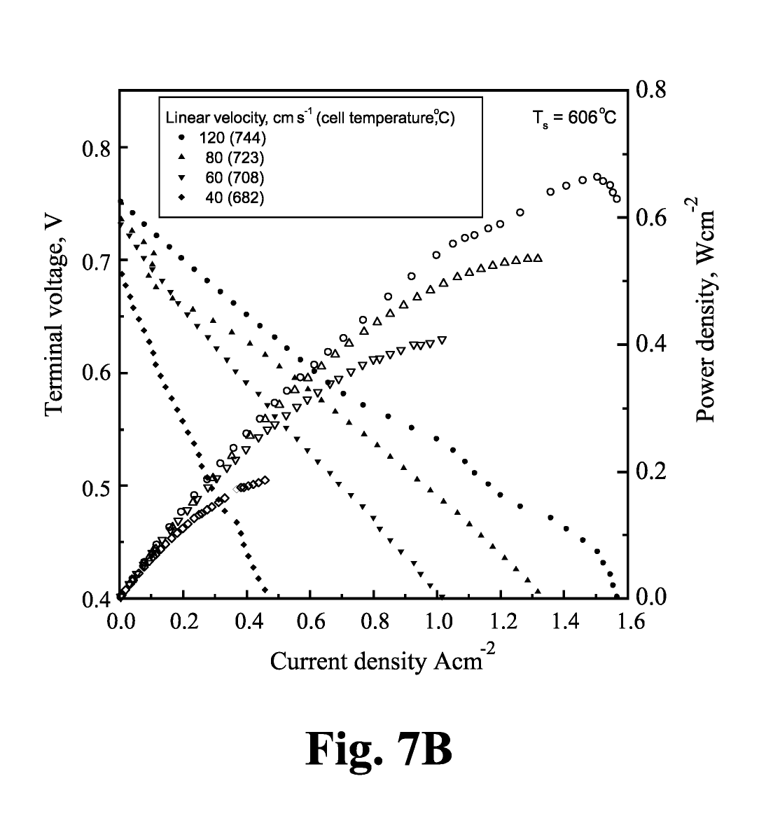

FIG. 7A shows the I-V discharge profile of the anode 16 supported porous YSZ electrolyte cell 12 in the air-fuel (air/methane) mixture 20 at 606° C. furnace temperature at higher gas flow rates. The anode 16 and the cathode 18 are exposed to the same gas mixture 20. An open circuit voltage was measured as high as 0.75 V and the maximum power density of 0.66 W/cm² was measured at 900 cubic centimeters per minute gas flow rate. FIG. 7B shows the impedance spectra corresponding to the results shown in FIG. 7A for higher gas flow rates.

### EXAMPLES

### Example 1

A fuel cell 12 was prepared by screen printing an electrolyte layer 14 having a thickness of 18 μm and having a composition of YSZ (approximately 16 mole percent yttria and the balance substantially zirconia) onto a 0.7 mm thick NiO-YSZ (80 weight percent NiO and 20 weight percent YSZ) substrate and sintered at 1400 degrees Celsius for one hour. A cathode layer 18 of La_{0.8}Sr_{0.2}Co_{0.2}Fe_{0.8}O₃ (LSCF) was screen printed onto the now-porous electrolyte 14 and annealed at 1000° C. for one hour. The fuel cell device 12 was then heated to 556 degrees Celsius and a fuel/oxidant mixture 20 (17 volume percent methane and 83 volume percent air) was flowed thereover. Pt and Au mesh were used as current collectors with the size adjusted to the area of the cathodes, which was 0.18 cm². Gas flow controllers maintained the gas flow between 300˜900 cm³ min⁻¹, which gave a linear velocity (gas flow rate/gas flow cross section area where cell was placed) over the fuel cell device 12 of from 40˜120 centimeters per second (cm s⁻¹).

### Example 2

A fuel cell 12 was prepared by screen printing an electrolyte layer 14 having a thickness of 18 μm and having a composition of YSZ (approximately 16 mole percent yttria and the balance substantially zirconia) onto a 0.7 mm thick NiO-YSZ (80 weight percent NiO and 20 weight percent YSZ) substrate and sintered at 1400 degrees Celsius for one hour. A cathode layer 18 of La_{0.8}Sr_{0.2}Co_{0.2}Fe_{0.8}O₃ (LSCF) was screen printed onto the now-porous electrolyte 14 and annealed at 1000° C. for one hour. The fuel cell device 12 was then heated to 606 degrees Celsius and a fuel/oxidant mixture 20 (17 volume percent methane and 83 volume percent air) was flowed thereover. Pt and Au mesh were used as current collectors with the size adjusted to the area of the cathodes, which was 0.18 cm⁻². Gas flow controllers maintained the gas flow between 300˜900 cm³ min⁻¹, which gave a linear velocity (gas flow rate/gas flow cross section area where cell was placed) over the fuel cell device 12 of from 40˜120 centimeters per second (cm s⁻¹). A maximum power density of about 0.66 W cm⁻² was obtained at a cell temperature of 744° C. (set temperature=606° C.) with a current density of 1.5 A cm⁻² and cell voltage of 0.44 V at 120 cm s⁻¹ linear velocity.

### Example 3

A fuel cell 12 having a 20 μm thick Gd-doped CeO₂ electrolyte layer 14 with a 0.8 mm thick Ni—ZrO₂ (35 volume percent Ni with the balance substantially zirconia) anode 16 and a La_{0.8}Sr_{0.2}Cu_{0.8}Mg_{0.2}O₃ cathode layer 18. The fuel cell was annealed at 1100° C. until porous. The fuel cell device 12 was then heated to at least about 300 degrees Celsius and a fuel/oxidant mixture 20 (25 volume percent butane and 75 volume percent air) was flowed thereover. Pt and Ag mesh were used as current collectors with the size adjusted to the area of the cathodes, which was about 0.25 cm². The gas mixture 20 was maintained at a velocity of about 80 centimeters per second (cm s⁻¹).

### Example 4

A fuel cell 12 having a 15 μm thick porous ionically conducting doped CeO₂ electrolyte layer 14 with a 0.9 mm thick porous CoO₂ anode 16 and an acceptor doped LaMnO₃ cathode layer 18. The fuel cell was annealed at 1100° C. and a porous electrolyte 14 microstructure was obtained. The fuel cell device 12 was then heated to at least about 700 degrees Celsius and a fuel/oxidant mixture 20 (15 volume percent propane and 85 volume percent oxygen rich nitrogen) was flowed thereover. Pd and Au mesh were used as current collectors with the size adjusted to the area of the cathode, which was about 0.20 cm². The gas mixture 20 was maintained at a velocity of between about 50 and about 100 centimeters per second (cm s⁻¹).

While the novel technology has been illustrated and described in detail in the drawings and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nigh-infinite number of insubstantial changes and modifications to the above-described embodiments and that it would be impractical to attempt to describe all such embodiment variations in the present specification. Accordingly, it is understood that all changes and modifications that come within the spirit of the novel technology are desired to be protected.

What is claimed is:

1. A method of extracting electrochemical energy from hydrocarbon fluids, comprising:
positioning an anode layer and a spaced cathode layer on a porous, non-densified yttria-doped zirconia electrolyte substrate;
flowing fuel-oxidant mixture directed over the electrolyte;
maintaining the electrolyte temperature in excess of about 575 degrees Celsius; and
extracting electrochemical energy from the anode and cathode;
wherein the fuel-oxidant mixture is flowed at a rate of between about 40 and about 120 centimeters per second;
wherein the anode and cathode enjoy an open circuit voltage of about 0.75 Volts.

2. The method of claim 1 wherein the fuel is selected from the set including methane, butane and propane; and wherein the oxidant is selected from the set including oxygen and air.

3. The method of claim 1 wherein the electrolyte layer is made of yttria stabilized zirconia; the anode layer is made of NiO—Y—ZrO₂; and the cathode layer is made of (La, Sr) (Co,Fe) O₃.

4. The method of claim 1 wherein the anode and cathode layers are porous.

5. A method of converting potential electrochemical energy in hydrocarbon fluids to electricity, comprising:
positioning a porous, non-densified yttria-doped zirconia electrolyte layer between a porous anode layer and a porous cathode layer to define a fuel cell;
placing the fuel cell into a flowing gaseous fuel-oxidant environment;
elevating the electrolyte temperature sufficiently to support the generation of electrochemical energy; and
generating an electric potential across fuel cell.

6. The method of claim 5 wherein the fuel-oxidant mixture is flowed at a rate of between about 40 and about 120 centimeters per second; wherein the electrolyte temperature is elevated to at least about 575 degrees Celsius; and wherein the anode and cathode enjoy an open circuit voltage of about 0.75 Volts.

7. The method of claim 5 wherein the electrolyte temperature is elevated to at least about 600 degrees Celsius.

8. The method of claim 5 wherein the anode layer is selected from the group consisting of NiO, yttria-doped zirconia and combinations of the same; and wherein the cathode layer is La_{0.8}Sr_{0.2}Co_{0.2}Fe_{0.8}O₃.

9. The method of claim 5 wherein the anode layer is selected from the group including CoO₂, NiO, NiO-YSZ, CeO₂, and Gd-doped CeO₂; and wherein the cathode layer is selected from the group including acceptor doped LaMnO₃, (La, Sr) (Co,Fe) O₃ and La_{0.8}Sr_{0.2}Co_{0.2}Fe_{0.8}O₃.

10. A method of extracting electrochemical energy from flowing hydrocarbon fluids, comprising:
positioning a porous electrolyte layer between a substantially porous anode layer and a substantially porous cathode layer to define a fuel cell;
flowing a mixture of hydrocarbon fuel and oxidant over the fuel cell;
heating the fuel cell to at least a predetermined minimum temperature; and
extracting electrochemical energy from fuel cell.

11. The method of claim 10 wherein the electrolyte layer is ionically conducting.

12. The method of claim 11 wherein the electrolyte layer is selected from the group including zirconia, doped zirconia, yttria stabilized zirconia, ceria, doped ceria, and lanthanum-strontium galleate.

13. The method of claim 10 wherein the hydrocarbon fuel-oxidant mixture is flowed at a linear velocity of between about 40 and about 120 centimeters per second; and wherein the anode and cathode enjoy an open circuit voltage of about 0.75 Volts.

14. The method of claim 10 wherein the hydrocarbon fuel-oxidant mixture is flowed at a rate of between about 300 and about 900 cubic centimeters per minute; and wherein a power density of about 0.65 Watts per square centimeter is extracted from the fuel cell.

15. The method of claim 12 wherein the anode layer is selected from the group including CoO₂, NiO, NiO—YSZ, CeO₂, and Gd-doped CeO₂; and wherein the cathode layer is selected from the group including acceptor doped LaMnO₃, (La, Sr) (Co,Fe) O₃ and La_{0.8}Sr_{0.2}Co_{0.2}Fe_{0.8}O₃.

16. The method of claim 12 wherein the anode layer is selected from the group consisting of NiO, yttria-doped zirconia and combinations of the same; and wherein the cathode layer is La_{0.8}Sr_{0.2}Co_{0.2}Fe_{0.8}O₃.

17. The method of claim 10 wherein the electrolyte is a protonic conductor.

18. The method of claim 17 wherein the electrolyte is selected from the group including Ba(Y)CeO₃ and Sr(Y)CeO₃.

19. The method of claim 10 wherein the fuel cell is heated by an external heat source.

20. The method of claim 10 wherein the fuel cell is at least partially self heated.
